(19) United States
(12) Patent Application Publication
(10) Pub. No.: US 2010/0040213 A1
(43) Pub. Date: Feb. 18, 2010

(54) HOME APPLIANCE AND HOME APPLIANCE SYSTEM

(75) Inventors: Hyung Jun PARK, Changwon-si (KR); Hae Yong Kang, Changwon-si (KR); Koon Seok Lee, Changwon-si (KR); Yong Tae Kim, Changwon-si (KR)

Correspondence Address: KED & ASSOCIATES, LLP, P.O. Box 221200, Chantilly, VA, 20153-1200, US

(73) Assignee: LG Electronics Inc.

(21) Appl. No.: 12/432,132

(22) Filed: Apr. 29, 2009

Related U.S. Application Data
(60) Provisional application No. 61/049,220, filed on Apr. 30, 2008.
(60) Provisional application No. 61/049,236, filed on Apr. 30, 2008.

(30) Foreign Application Priority Data
Apr. 30, 2008 (KR) 10-2008-0040678
Apr. 30, 2008 (KR) 10-2008-0040679

(51) Int. Cl. H04M 11/00

(52) U.S. Cl. 379/106.01

(57) ABSTRACT

A home appliance and a home appliance system are provided. The home appliance converts product information into at least one acoustic signal, and an output device outputs the at least one acoustic signal as a sound. Further, the home appliance system may include a management device. The management device may receive the sound and read the product information contained in the sound. The home appliance may prevent data loss that may occur upon transmission of a sound through a communications network by converting the product information into acoustic signals of different amplitude or frequency bands.

This application claims priority to U.S. Provisional Application No. 61/049,220, filed Apr. 30, 2008, U.S. Provisional Application No. 61/049,236, filed Apr. 30, 2008, Korean Patent application No. 10-2008-0040678 filed in Korea on Apr. 30, 2008 and Korean Patent application No. 10-2008-0040679 filed in Korea on Apr. 30, 2008 which are hereby incorporated by reference.

### BACKGROUND

1. Field

A home appliance and a home appliance system including a home appliance are disclosed herein.

2. Background

Home appliances and home appliance systems are known. However, they suffer from various disadvantages.

### BRIEF DESCRIPTION OF THE DRAWINGS

Embodiments will be described in detail with reference to the following drawings in which like reference numerals refer to like elements, and wherein:

FIG. 1 is a perspective view of a home appliance in the form of a laundry treatment machine according to an embodiment;

FIG. 2 is a schematic block diagram of the laundry treatment machine of FIG. 1;

FIG. 3 is a graph showing amplitude characteristics of an acoustic signal containing product information generated by the conversion device of FIG. 2;

FIG. 4 is a schematic view of a home appliance in the form of a laundry treatment machine system according to an embodiment;

FIG. 5 is an enlarged perspective view of the control panel of FIG. 1;

FIG. 6 is an enlarged view of part A of FIG. 5;

FIG. 7 is another embodiment of part A of FIG. 5;

FIG. 8 is another embodiment of part A of FIG. 5;

FIG. 9 is a schematic block diagram of the laundry treatment machine according to another embodiment.

FIG. 10 is a graph showing frequency characteristics of an acoustic signal containing product information generated by the conversion device of FIG. 9;

FIG. 11 is a schematic block diagram of a home appliance system in the form of a laundry treatment machine system according to another embodiment;

FIG. 12 is a flow chart illustrating. a control flow of a laundry treatment machine system according to another embodiment; and

FIG. 13 is a flow chart illustrating a control flow of a laundry treatment machine system according to another embodiment.

### DETAILED DESCRIPTION

Conventionally, when problems occur when a user is using a home appliance, the user usually calls a service center to find out the cause. European Patent No. 0510519 discloses a technique of sending fault information of a home appliance to a service center using a telephone network via a modem connected to the home appliance. With this technique, the modem must be connected to the home appliance. However, a home appliance, such as a laundry treatment machine, may be installed outdoors, and thus, there are location restrictions that must be considered to connect the laundry treatment machine and the telephone network.

U.S. Pat. No. 5,987,105 discloses a technique of converting fault information of a home appliance into a sound of an audible frequency band using a telephone network and sending the same to a service center via a telephone. However, with this technique, signal interference may occur depending on the surrounding environment when converting the fault information of the home appliance into the sound of an audible frequency and then sending the same to a telephone handset, and data loss may occur depending on characteristics of the telephone network.

Embodiments disclosed herein relate to a home appliance and a home appliance system. Embodiments of a home appliance and a home appliance system will be described using a laundry treatment machine and laundry treatment machine system as examples. However, embodiments are not limited to a laundry treatment machine and a laundry treatment machine system, but rather, may be employed as other home appliances and home appliance systems. Such home appliances may include, for example, a TV, an air conditioner, a washing machine, a refrigerator, an electric rice cooker, or a microwave or conventional oven.

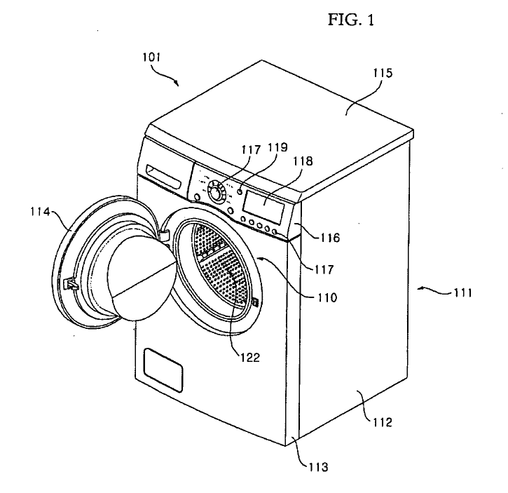

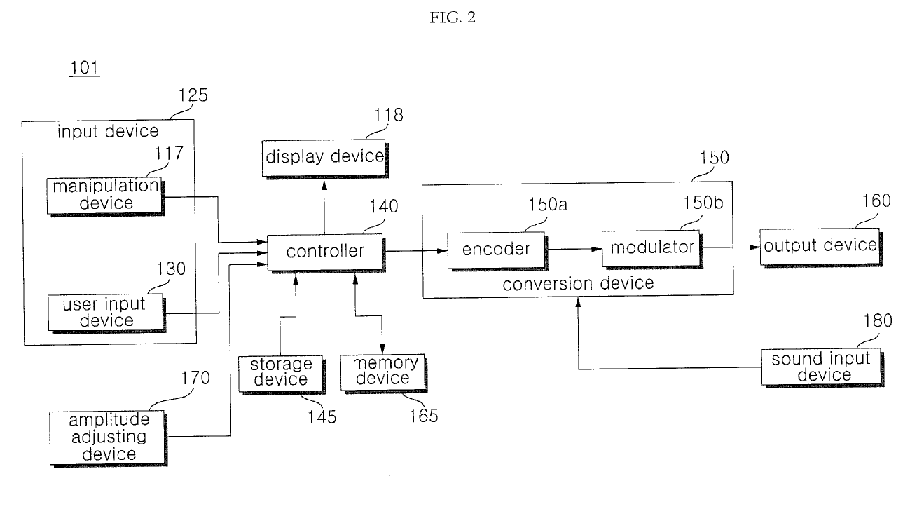

FIG. 1 is a perspective view of a home appliance in the form of a laundry treatment machine according to an embodiment. FIG. 2 is a schematic block diagram of the laundry treatment machine of FIG. 1. Referring to FIGS. 1 and 2, the laundry treatment machine 101 may include a cabinet 111, a tub 122 disposed inside the cabinet 111 that performs washing of laundry, a motor (not shown) that drives the tub 122, a washing fluid supply device (not shown) that supplies washing fluid to the tub 122, and a drainage device (not shown) that discharges washing fluid from the tub 122 after washing is completed.

The cabinet 111 may include a cabinet body 112, a cabinet cover 113 coupled to the cabinet body 112, a control panel 116 disposed over the cabinet cover 113 that controls operation of the laundry treatment machine 101, and a top plate 115. The cabinet cover 113 may include a hole 110 through which laundry may be put into/removed from the tub 122 and a door 114 that rotates to open and close the hole 110.

The control panel 116 may include manipulation device 117 configured to allow manipulation of an operation of the laundry treatment machine 101, a speaker or buzzer 119 may be configured to notify a user of an operation state of the laundry treatment machine 101, for example, by voice, and a display device 118 that displays the operation state in the form of an image corresponding to signal from the controller 140.

Referring to FIG. 2, the laundry treatment machine 101 may include an input device 125 configured to receive input signals from outside of the laundry treatment machine 101, a storage device 145 that stores product information, the controller 140 which loads the product information stored in the storage device 145 and outputs a control signal when the input device 125 receives the input signal including a control command for fault diagnosis, a conversion device 150 that converts the control signal which includes product information into at least one acoustic signal, and an output device 160 that outputs a sound corresponding to the at least one acoustic signal.

A storage device 145 can be included in the controller 140. EEPROM (Electrically Erasable Programmable Read-Only Memory) can be the storage device 145.

The laundry treatment machine 101 may further include a memory device 165 configured to store a data transmitted from the input device 125 temporarily

The input device 125 may include a user input device 130 that receives input of the control command for fault diagnosis. When the user inputs the control command or signal conversion command through the user input device 130, the controller 140 may control the conversion device 150 to convert the product information into the at least one acoustic signal. The output device 160 may output the at least one acoustic signal generated by the conversion device 150 as a sound.

The conversion device 150 may include an encoder 150a and a modulator 150b. The encoder 150a may encode each bit of the product information into symbols. The modulator 150b may modulate the symbols onto an analog signal. The modulated signal, e.g. the at least one acoustic signal, may then be output to the output device 160. The output device 160 may receive the modulated signal, e.g. the at least one acoustic signal, and output the same as a sound.

The modulator 150b may modulate the symbols using, for example, any one of a frequency shift keying method, an amplitude shift keying method, or a phase shift keying method. The frequency shift keying method is a modulation method that modulates a data value of the product information onto a signal of a predetermined frequency. The amplitude shift keying method is a modulation method that varies a level of amplitude in response to a data value. The phase shift keying method is a modulation method that varies a phase according to a data value of the product information.

The output device 160 may be a buzzer or a speaker. The product information may include, for example, operation information and fault information of the product.

The laundry treatment machine 101 may further include an amplitude adjusting device 170 that adjusts an amplitude of the at least one acoustic signal. That is, a user may set the amplitude of the acoustic signal through the amplitude adjusting device 170. The controller 140 may control the conversion device 150 to convert the product information into the at least one acoustic signal according to the set amplitude.

Meanwhile, the input device 125 may further include a manipulation device 117. A user may input an operation command through the manipulation device 117. A user may select an operation course, e.g, a washing course, a rinsing course, a dehydrating course or a drying course, and also set up various kinds of options, e.g, an operation time of the each operation course through the manipulation device 117.

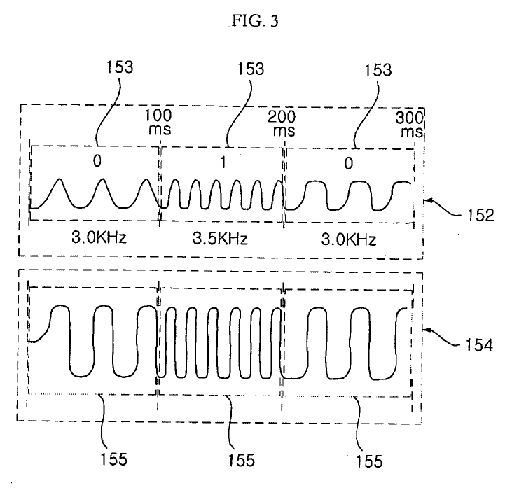

FIG. 3 is a graph showing amplitude characteristics of an acoustic signal containing product information generated by the conversion device 150 of FIG. 2. When the user inputs a control command or signal conversion command, the controller 140 may control the conversion device 150 to modulate the product information onto a first acoustic signal 152 having a preset frequency and amplitude.

The first acoustic signal 152 may include a plurality of first unit signals 153. Each of the first unit signals 153 may be a first frequency signal or a second frequency signal within the preset frequency band. Further, the first frequency signal and the second frequency signal may be signals having a different frequency from each other. Hereinafter, descriptions will be made with respect to a case in which the first acoustic signal 152 and the second frequency signal 154 are signals within a frequency band of approximately 2 Khz to approximately 3 Khz. For example, the first frequency signal may be a frequency signal of approximately 2.5 Khz, and the second frequency signal may be a frequency signal of approximately 2.9 Khz.

The product information may include digital data comprising logical data 0 or 1. That is, the product information may be stored as digital data in a storage device 145 provided in the laundry treatment machine 101, and the conversion device 150 may be a digital-analog converter (hereinafter, AD converter) that converts or modulates the digital data onto an electrical signal having a certain frequency. Of course, the AD converter may be implemented so as to convert an analog signal to a digital signal.

When converting digital data containing the product information into an acoustic signal which is an analog signal, the conversion device 150 may modulate data of ‘0’ onto a first frequency signal, and modulate data of ‘1’ into a second frequency signal. The controller 140 may retrieve data stored in the storage device 145, and may control the conversion device 150 to generate the first frequency signal having approximately 2.5 Khz during a preset set time t if data ‘0’ is retrieved, and generate the second frequency signal having approximately 2.9 Khz during a symbol time t if data of ‘1’ is retrieved. Hereinafter, descriptions will be made using as an example a symbol time t≈100 ms.

The user may set an amplitude of the signal time using the amplitude adjusting device 170. When the user sets the amplitude through the amplitude adjusting device 170, the controller 140 may control the conversion device 150 to convert the product information into an acoustic signal of the set amplitude, and the output device 160 may output a sound of the set amplitude. If signal interference occurs due to characteristics of the surrounding environment or communications network, the user may increase a loudness of the sound by increasing the amplitude of the acoustic signal via the amplitude adjusting device 170. On the other hand, if the user wants a quiet environment, the loudness of the sound may be decreased by decreasing the amplitude of the acoustic signal.

That is, when the user sets the amplitude through the amplitude adjusting device 170, the controller 140 may control the conversion device 150 to convert the product information into a second acoustic signal 154. The second acoustic signal 154 may include at least one of a third frequency signal having the same frequency as the first frequency signal and a different amplitude from that of the first frequency signal, and a fourth frequency signal having the same frequency as the second frequency signal and a different amplitude from that of the second frequency signal. That is, the first acoustic signal 152 and the second acoustic signal 154 may have the same frequency but different amplitudes.

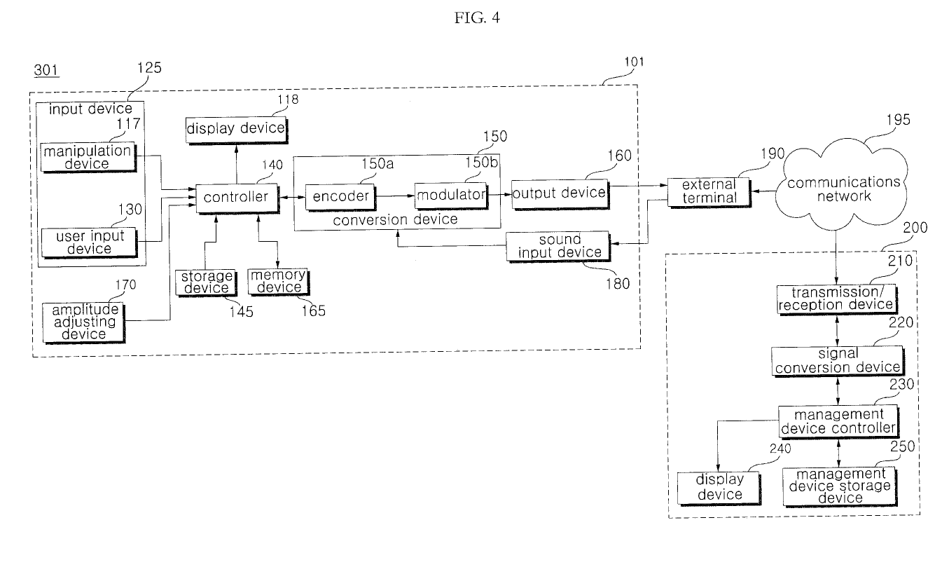

FIG. 4 is a schematic diagram of a home appliance system in the form of a laundry treatment machine system according to an embodiment. Referring to FIG. 4, the laundry treatment machine system 301 may include the above-described laundry treatment machine 101, an external terminal 190 that communicates with a communications network 195, and a management device 200 that receives a sound containing the product information and inversely converts the same into product information.

The management device 200 may include a transmission/reception device 210 that transmits the signal received through the communications network 195 to a signal conversion device 220, and upon transmission of a predetermined signal from the signal conversion device 220, sends a signal to the external terminal 190 through the communications network 195, the signal conversion device 220 that converts the sound received by the transmission/reception device 210 into a signal readable by a management device controller 230, the management device controller 230 that reads the signal received from the signal conversion device 220, and a management device storage device 250 that stores an operation system that controls the management device 200 and the product information.

The management device controller 230 may comprise a computer system that performs overall control of the management device 200, reads the product information by analyzing the data, and analyzes, for example, fault information of the product contained in the product information via the operation system stored in the management device storage device 250. The signal output to the signal conversion device 220 may be a digital signal readable by the computer system.

Meanwhile, the communications network 195 may comprise a wired or mobile communications network, and the external terminal 190 may comprise a wired/wireless telephone or a mobile communication terminal. In homes, the laundry treatment machine 101 may be installed outdoors, for example, on a veranda, and communication equipment, such as a mobile communication terminal, may be used which is easy to carry in order to receive a sound output through the output device 160.

The transmission/reception device 210 may be connected to the external terminal 190 through the communications network 195, and may be electrically connected to the signal conversion device 220. That is, the transmission/reception device 210 may be a kind of a modem that converts the signal containing the product information received through the communications network 195 and receives a predetermined signal from the signal conversion device 220 to convert it into a transmittable signal through the communications network 195.

The signal conversion device 220 may function as an AD converter that receives an analog signal containing the product information from the transmission/reception device 210 and converts it into a digital signal. Thus, the signal output from the signal conversion device 220 may be a digital signal, which is read by the management device controller 230. That is, the management device controller 230 may serve to perform overall control of the management device 200 and read the digital signal containing the product information output from the signal conversion device 220. The management device 200 may further include a display device 240 that allows a repairman to see operation information or fault information contained in the product information by outputting the product information in the form of an image.

If the management device controller 230 cannot read the digital signal, that is, if an error occurs during the reading of data containing the product information, the management device controller 230 may send a signal containing a re-transmit command through the transmission/reception device 220. The re-transmit command may be received by the external terminal 190 through the communications network 195, and the user may listen to the re-transmit command through a speaker of the external terminal 190. That is, the re-transmit command may comprise voice information, such as “data was sent inappropriately, please press the send button again.”

If the user inputs the control command again through the user input device 130, the controller 140 may control the conversion device 150 to convert the product information into a second acoustic signal 154 having a larger amplitude than that of the first acoustic signal 152. Of course, the user may set the amplitude of the second acoustic signal 154 using the amplitude adjusting device 170 in advance, before inputting the operation control command using the user input device 130. In such a case, the controller 140 may control the conversion device 150 to convert the product information into the second acoustic signal 154 according to the set amplitude, and the output device 160 may output a second sound corresponding to the second acoustic signal 154.

Meanwhile, the laundry treatment machine 101 may further include a sound input device 180 that receives a sound. If there is a problem with the operation of the laundry treatment machine 101, the user may make a call connection with the management device 200 through the external terminal 190, and then move a microphone (not shown) of the external terminal 190 to within a close distance to the output device 160 of the laundry treatment machine 101 in a call connection state. Afterwards, the user may input an control command for fault diagnosis through the user input device 130. When the control command is input, the controller 140 may control the conversion device 150 to convert the product information into a first acoustic signal 152 and the output device 160 may output a first sound corresponding to the first acoustic signal 152.

Meanwhile, the management device controller 230 may read the digital signal containing the product information and output it through the signal conversion device 220. If it is difficult to read the digital signal, the management device controller 230 may control the transmission/reception device 210 to send a re-transmit command.

Meanwhile, the sound input device 180 may be a microphone that receive sound. A sound input into the sound input device 180 may be converted into an analog signal, and the conversion device 150 may convert the analog signal into a digital signal. The controller 140 may read the digital signal, and if a retransmit command is contained in the digital signal, control the conversion device 150 to convert the product information into a second acoustic signal 154 and the output device 160 to output the second sound corresponding to the second acoustic signal 154. That is, in this case, the conversion device 150 may serve to convert an analog signal into a digital signal.

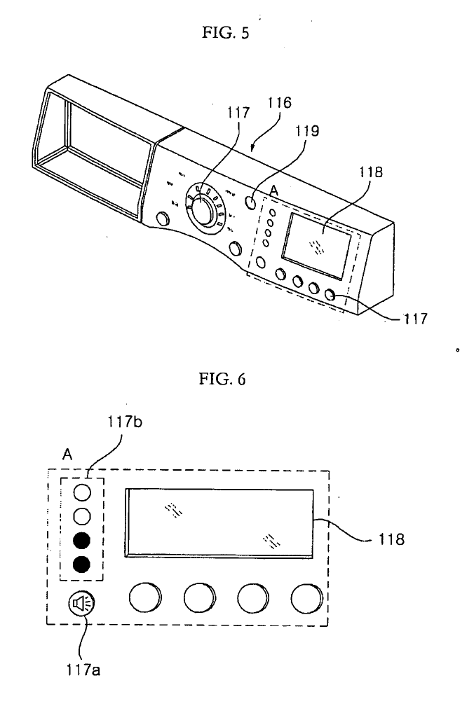

FIG. 5 is an enlarged perspective view of the control panel 116 of FIG. 1. FIG. 6 is an enlarged view of part A of FIG. 5. Referring to FIG. 5, part A may include a display device 118 disposed on the control panel 116, manipulation device 117, an amplitude adjusting device 117a configured to allow a user to set the amplitude of the acoustic signal, and another display device 117b that displays a loudness of a sound corresponding to the acoustic signal output through the output device 160. The amplitude adjusting device 117a may be a device capable of increasing or decreasing the loudness of a sound output through the output device 160 according to a number of times the user presses it, and may comprise a push-type electronic/mechanical button. In other words, when the user repetitively presses the amplitude adjusting device 117a a predetermined number of times, the loudness of the sound may be increased, and then decreased after a predetermined level is reached.

The display 117b may include a plurality of LED devices that display the loudness of the sound adjusted by the user. That is, the plurality of LED devices may be sequentially switched on starting from a bottom to a top along with the increase of the loudness of the sound, thereby allowing the user to visually recognize a current loudness of the sound.

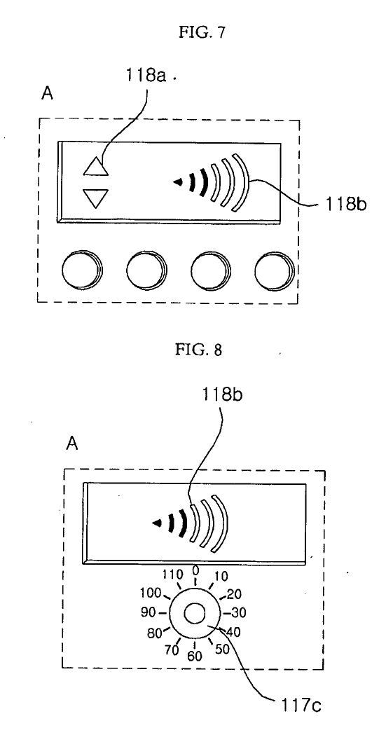

FIG. 7 is another embodiment of part A of FIG. 5. Referring to FIG. 7, the display device 118 may comprise a touch screen. That is, the display device 118 may include a device that detects a pressure disposed on a surface thereof, and hence, when the user applies a pressure on the surface of the display 118, the pressure is detected and signalized and an image is output on the surface.

The amplitude adjusting device 118a may be provided in a button shape displayed as an image on the display device 118. When pressure is applied in a region in which the button shape is displayed, an amplitude adjusting command may be input into the controller 140, thus adjusting the amplitude of the acoustic signal. At this time, the loudness of the sound output through the output device 160 may be displayed as an image 118b on the display device 118.

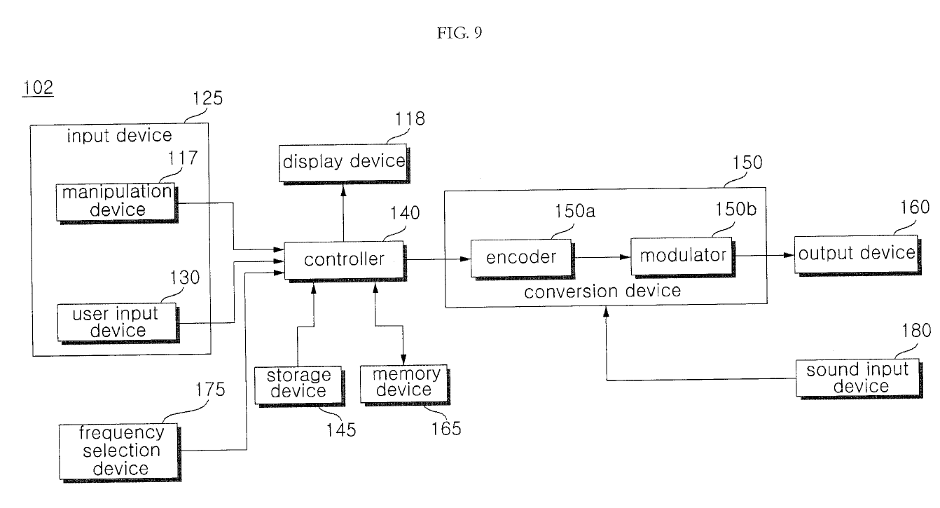

FIG. 8 is another embodiment of part A of FIG. 5. Referring to FIG. 8, the amplitude adjusting device 117c may be in the form of a dial. For example, the amplitude of the acoustic signal may be adjusted by turning a dial 117c to the left or right, and the loudness of the sound output in response to the acoustic signal displayed as an image 118b by the display device 118.

Embodiments disclosed herein provide a home appliance that converts product information into an acoustic signal and outputs a sound corresponding to the acoustic signal through an output unit or device driven by the acoustic signal. Further, embodiments disclosed herein provide a home appliance and a home appliance system that can correctly transmit product information by adjusting a sound level of an acoustic signal containing the product information.

Embodiments disclosed herein further provide a home appliance that may include a conversion unit or device that converts product information into an acoustic signal, an output unit or device that outputs a sound corresponding to the acoustic signal, a control unit or controller that adjusts an amplitude of the acoustic signal by controlling the conversion unit, and an input unit or device that inputs a signal conversion command into the control unit to allow the conversion unit to convert the product information into the acoustic signal.

Embodiments disclosed herein further provide a home appliance system that may include a home appliance that converts product information into an acoustic signal upon receipt of a signal conversion command to output a sound corresponding to the acoustic signal and adjusts an amplitude of the acoustic signal, an external terminal connected to a communications network that transmits the sound via the communications network, and a management device that receives the sound and inversely converts the received signal one into the product information.

In a case where a sound is distorted by environmental factors such that it fails to deliver correct product information, the home appliance according to embodiments disclosed herein is able to stop the outputting of a sound through an operation unit or device. The user may then re-output the product information correctly after eliminating the peripheral causes of signal interference.

The home appliance according to embodiments may minimize data loss caused by signal interference that may occur according to the use environment because the amplitude of an acoustic signal generated by the conversion unit may be adjusted.

The home appliance system according embodiments may be capable of receiving of correct product information by a re-transmission request made by the management device, if there is a loss in the transmitted product information, in order to correctly transmit a sound containing the product information to the management device

FIG. 9 is a schematic block diagram of the laundry treatment machine according to another embodiment. Referring to FIG. 9, the laundry treatment machine 102 may include an input device 125 configured to receive input of a control command, a conversion device 150 that converts product information into at least one acoustic signal, and an output device 160 that outputs a sound corresponding to the at least one acoustic signal.

The input device 125 may include a user input device 130 configured to receive input of an control command for fault diagnosis from a user. When the user inputs the control command through the user input device 130, a controller 140 may control the conversion device 150 to convert the product information into the at least one acoustic signal. The output device 160 may output the at least one acoustic signal generated by the conversion device 150 to outside of the laundry treatment machine 102. The acoustic signal may be an electrical signal having a certain frequency that drives the output device 160, to output a sound, and the output device 160 may output a sound corresponding to frequency characteristics of the acoustic signal.

That is, the conversion device 150 may include an encoder 150a and a modulator 150b. The encoder 150a may encode each bit of the product information into symbols. The modulator 150b may modulate the symbols onto an analog signal. The modulated signal, e.g. the at least one acoustic signal, may then be output to the output device 160. The output device 160 may receive the modulated signal, e.g. the at least one acoustic signal, and output the same as a sound.

The modulator 150b may modulate the symbols using, for example, any one of a frequency shift keying method, an amplitude shift keying method, or a phase shift keying method. The frequency shift keying method is a modulation method that modulates a data value of the product information onto a signal of a predetermined frequency. The amplitude shift keying method is a modulation method that varies a level of amplitude in response to a data value. The phase shift keying method is a modulation method that varies a phase according to a data value of the product information.

The output device 160 may be a buzzer or a speaker. The product information may include, for example, operation information or fault information of the product.

Meanwhile, the input device 125 may further include a manipulation device 117. A user may input an operation command through the manipulation device 117. The user may select an operation course, e.g, a washing course, a rinsing course, a dehydrating course or a drying course, and also set up various kinds of options, e.g, an operation time of the each operation course through the manipulation device 117.

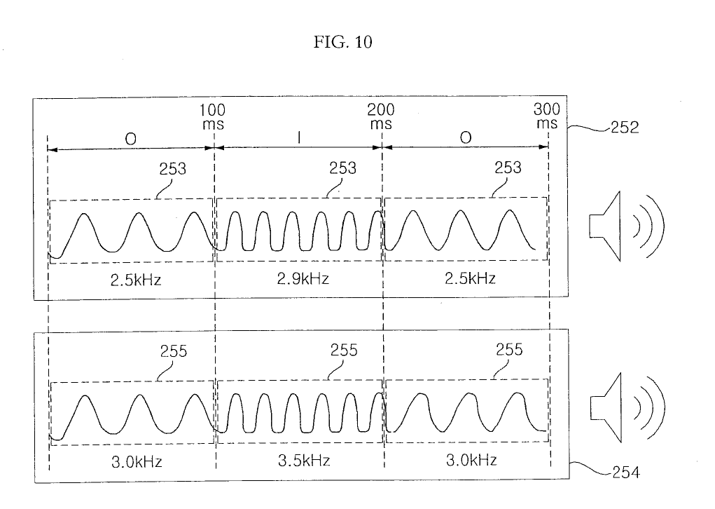

FIG. 10 is a graph showing frequency characteristics of an acoustic signal containing product information generated by the conversion device 150 of FIG. 9. When a user inputs the control command, the controller 140 may control the conversion device 150 to convert the product information into a first acoustic signal 252, which may be a signal within a preset frequency band.

The first acoustic signal 252 may include a plurality of first unit signals 253, and each of the first unit signals 253 may be a first frequency signal or a second frequency signal within the preset frequency band. Further, the first frequency signal and the second frequency signal may be signals having a different frequency from each other. Hereinafter, descriptions will be made with respect to a case in which the first acoustic signal 252 and the second frequency signal 254 are signals within a frequency band of ˜2 Khz to ˜3 Khz. For example, the first frequency signal may be a frequency signal of ˜2.5 Khz, and the second frequency signal may be a frequency signal of ˜2.9 Khz.

The product information may include digital data comprising logical data 0 or 1. That is, the product information may be stored as digital data in a storage device 145 provided in the laundry treatment machine 102, and the conversion device 150 may be a kind of a digital-analog converter (hereinafter, AD converter) that converts the digital data into an electrical signal having a certain frequency. Of course, the AD converter may be implemented so as to convert an analog signal to a digital signal.

When converting digital data containing the product information into an acoustic signal which is an analog signal, the conversion device 150 may convert data of ‘0’ into a first frequency signal, and converts data of ‘1’ into a second frequency signal. The controller 140 may retrieve data stored in the storage device 145, and may control the conversion device 150 to generate the first frequency signal having ˜2.5 Khz during a preset set time t if data ‘0’ is retrieved, and generate the second frequency signal having ˜2.9 Khz during a time t if data of ‘1’ is retrieved. Hereinafter, descriptions will be made using as an example t=100 ms.

The laundry treatment machine 102 may output sounds containing the product information and having different frequency properties a plurality of times in order to deliver product information more correctly. That is, the conversion device 150 may convert the product information into a plurality of acoustic signals having a different frequency band from each other, and the output device 160 may consecutively output a plurality of sounds having different frequency properties corresponding to the plurality of acoustic signals. Hereinafter, descriptions will be made under the assumption that a second sound is output after the outputting of a first sound.

The conversion device 150 may convert the product information into a first acoustic signal 252, and may then convert the product information into a second acoustic signal 254. The second acoustic signal 254 may be a signal having a different frequency from that of the first acoustic signal 252. The second acoustic signal 254 may include a plurality of second unit signals 255, and the second unit signals 255 may be a third frequency signal included in the frequency band of the second acoustic signal 254 or a fourth frequency signal having a different frequency from that of the third frequency signal. Hereinafter, descriptions will be made using as an example a second acoustic signal 254 having a bandwidth signal of ˜3 Khz to ˜4 Khz, a third frequency signal having a frequency signal of ˜3.0 Khz, and a fourth frequency signal having a frequency signal of ˜3.5 Khz.

As described above, since the conversion device 150 may convert the product information into first and second acoustic signals 254 having a different frequency from each other, the output device 160 may resultantly output a first sound corresponding to the first acoustic signal 252 and a second sound corresponding to the second acoustic signal 254. The first sound and the second sound may contain the product information, respectively.

Accordingly, even when signal interference occurs due to the surrounding environment of the laundry treatment machine 102, the laundry treatment machine 102 may consecutively output the product information as the first sound and second sound having different frequency properties from each other, thereby delivering the product information more correctly. Of course, the output device 160 may consecutively output two or more sounds having different frequencies from each other.

Referring to FIG. 9, the laundry treatment machine 102 may include a frequency selection device 175 for selection of the frequency band of the acoustic signals and the frequency of the unit signals constituting the acoustic signals. That is, a user may input the frequency band of the acoustic signals and a frequency selection command for each of first and second frequency signals included in the acoustic signals through the frequency selection device 175. According to the frequency selection command, the controller 140 may control the conversion device 150 to convert the product information into the acoustic signals according to the result of selection. Meanwhile, the frequency selection device 175 may be configured so as to select the frequency band of the acoustic signals and the frequency of each of the first and second frequency signals according to a preset multiple frequency setting mode.

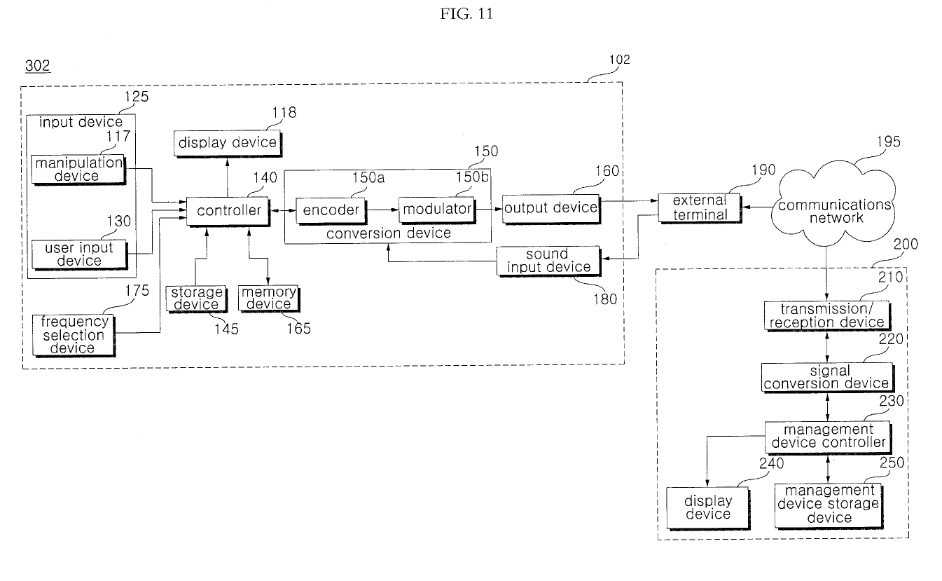

FIG. 11 is a schematic block diagram of a home appliance system in the form of a laundry treatment machine system according to another embodiment. Referring to FIG. 11, the laundry treatment machine system 302 may include the above-described laundry treatment machine 102, an external terminal 190 that communicates with a communications network 195, and a management device 200 that receives a sound containing the product information and inversely converts the same into product information.

The management device 200 may include a transmission/reception device 210 that transmits the signal received through the communications network 195 to a signal conversion device 220, and upon transmission of a predetermined signal from the signal conversion device 220, sends it to the external terminal 190 through the communications network 195, a signal conversion device 220 that converts the sound received by the transmission/reception device 210 into a signal readable by a management device controller 230, the management device controller 230 that reads the signal received from the signal conversion device 220, and a management device storage device 250 that stores an operation system that controls the management device 200 and the product information.

The management device controller 230 may comprise a computer system that performs overall control of the management device 200, reads the product information by analyzing the data, and analyzes fault information of the product contained in the product information through the operation system stored in the management device storage device 250. The signal output to the signal conversion device 220 may be a digital signal readable by the computer system.

The communications network 195 may comprise a wired or mobile communications network, and the external terminal 190 may comprise a wired/wireless telephone or a mobile communication terminal. In homes, the laundry treatment machine 102 may be installed outdoors, for example, on a veranda, and communication equipment, such as a mobile communication terminal, may be used that is easy to carry in order to receive a sound output through the output device 160.

The transmission/reception device 210 may be connected to the external terminal through the communications network 195, and may be electrically connected to the signal conversion device 220. That is, the transmission/reception device 210 may be a kind of a modem that converts the signal containing the product information received through the communications network 195 and receives a predetermined signal from the signal conversion device 220 to convert it into a transmittable signal through the communications network 195.

The signal conversion device 220 may function as an AD converter that receives an analog signal containing the product information from the transmission/reception device 210 and converts it into a digital signal. The signal output through the signal conversion device 220 may be a digital signal, which is read by the management device controller 230.

The management device controller 230 may serve to perform overall control of the management device 200 and read the digital signal containing the product information output from the signal conversion device 220. If the management device controller 230 cannot read the digital signal, that is, if an error occurs during the reading of data containing the product information, the management device controller 230 may send a signal containing re-transmit request information or a re-transmit command through the transmission/reception device 220.

The management device 200 may further include a display 240 that allows a repairman to see operation information or fault information contained in the product information by outputting the product information in the form of an image.

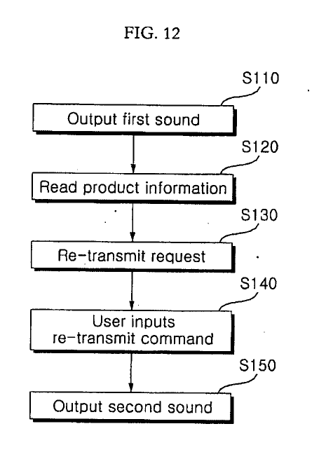

FIG. 12 is a block diagram of a control flow of a home appliance system in the form of a laundry treatment machine system according to another embodiment. Referring to FIGS. 11 and 12, if there is a problem with the operation of the laundry treatment machine 102, a user may make a call connection with the management device 200 through the external terminal 190, and then move a microphone (not shown) of the external terminal 190 to within a close distance of the output device 160 of the washing machine in a call connection state.

Next, the user may input an operation control command through the user input device 130. When the operation control command is input, the controller 140 may control the conversion device 150 to convert the product information into a first acoustic signal 252, and the output device 160 may output a first sound corresponding to the first acoustic signal 252, in step S130.

Next, the management device controller 230 may read the digital signal containing the product information and output the digital signal through the signal conversion device 150, in step S120. If it is difficult to read the digital signal, the management device controller 230 may control the transmission/reception device 210 to send a re-transmit command, in step S130.

The re-transmission command may be received by the external terminal 190 through the communications network 195, and the user may listen to the re-transmit command through a speaker of the external terminal 190. That is, the re-transmit command may comprise voice information, such as “data was sent inappropriately, please press the send button again.”

If the user inputs the re-transmit command through the input device 130, in step S140, the controller 140 may control the conversion device 150 to convert the product information into a second acoustic signal 254 and the output device 160 may output a second sound corresponding to the second acoustic signal 254, in step S150.

In other words, in a case where the user has received a re-transmit command from the management device 200 through the external terminal 190, it is determined whether to output the second sound having different frequency properties from those of the previously output first signal. In this case, the user may input the operation control command through the user input device 130 after determining the frequency characteristics of the second acoustic signal 254 through the selection device 170.

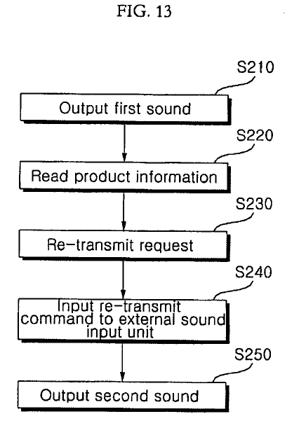

FIG. 13 is a block diagram of a control flow of a home appliance system in the form of a laundry treatment machine system according to another embodiment Referring to FIGS. 11 and 13, the laundry treatment machine 102 may further include a sound input device 180 that receives a sound from outside of the laundry treatment machine 102.

If there is a problem with the operation of the laundry treatment machine 102, the user may make a call connection with the management device 200 through the external terminal 190, and then move the microphone (not shown) of the external terminal 190 to within a close distance of the output device 160 of the laundry treatment machine 102 in a call connection state. Next, the user may input an operation control command through the user input device 130. When the operation control command is input, the controller 140 may control the conversion device 150 to convert the product information into a first acoustic signal 252, and the output device 160 may output a first sound corresponding to the first acoustic signal 252, in step S210.

Next, the management device controller 230 may read the digital signal containing the product information and output the digital signal through the signal conversion device 150, in step S220. If it is difficult to read the digital signal, the management device controller 230 may control the transmission/reception device 210 to send a re-transmit command, in step S230.

The sound input device 180 may comprise a microphone that receives a sound from outside of the laundry treatment machine 102. An external sound input into the sound input device 180 may be converted into an analog signal, and the conversion device 150 may convert the analog signal into a digital signal. The controller 140 may then read the digital signal, and if a re-transmit command is contained in the digital signal, may control the conversion device 150 to convert the product information into a second acoustic signal 254 and the output device 160 may output the second sound corresponding to the second acoustic signal 254, in step S250. That is, in this case, the conversion device 150 may serve to convert an analog signal into a digital signal.

Embodiments disclosed herein provide a home appliance that converts product information into an acoustic signal and outputs a sound corresponding to the acoustic signal through an output unit or device driven by the acoustic signal. Embodiments disclosed herein further provide a home appliance and a home appliance system that can correctly transmit product information by enabling acoustic signals containing the product information to be converted into acoustic signals of various frequency bands.

Embodiments disclosed herein provide a home appliance that may include a conversion unit or device that converts product information into an acoustic signal, an output unit or device that outputs a sound corresponding to the acoustic signal, a control unit or controller that adjusts a frequency band of the acoustic signal by controlling the conversion unit, and an input unit or device that inputs a signal conversion command into the control unit to allow the conversion unit to convert the product information into the acoustic signal.

Embodiments disclosed herein further provide a home appliance system that may include a home appliance that converts product information into an acoustic signal upon receipt of a signal conversion command to output a sound corresponding to the acoustic signal and adjust the frequency band of the acoustic signal an external terminal connected to a communications network to transmit the sound via the communications network, and a management device configured to receive the sound and inversely convert the received signal one into the product information.

In the case where a sound is disturbed according to the use environment, thus failing to deliver correct product information, the home appliance according to embodiments disclosed herein may be able to stop the outputting of a sound through an operation unit or device. The user may then re-output product information correctly after eliminating the peripheral causes of signal interference.

The home appliance according to embodiments disclosed herein may minimize data loss caused by signal interference that may occur according to the use environment because the conversion unit or device is able to convert product information into acoustic signals of various frequency bands.

The home appliance system according embodiments disclosed herein may be capable of receiving correct product information by a re-transmission request made by the management device, if there is a loss in the product information to be received, in order to correctly transmit a sound containing the product information to the management device.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. In a home appliance system that transmits product information of a home appliance to a management device through a wire/wireless communication network for fault diagnosis, and diagnoses fault of the home appliance,
an output device configured to output a sound;
an input device configured to received a control command from outside of the home appliance;
a controller that includes a storage device for storing the product information of the home appliance for the fault diagnosis, and loads the product information stored in the storage device and outputs a control signal to adjust the characteristic of the sound being output by the output device, when the control command for the fault diagnosis is input through the input device; and
a conversion device that converts the control signal which includes product information into at least one acoustic signal which operates the output device to output the sound corresponding to the at least one acoustic signal.

2. The home appliance of claim 1, wherein the controller adjusts the amplitude of the at least one acoustic signal and corresponding sound.

3. The home appliance of claim 2, further comprising an amplitude adjusting device configured to allow a user to set an amplitude of the at least one acoustic signal adjusted by the controller.

4. The home appliance of claim 3, further comprising a control panel provided with at least one of the input device or the amplitude adjusting device.

5. The home appliance of claim 4, wherein the amplitude adjusting device comprises at least one of a push type adjusting device that receives input by clicking, a touch type device that receives input by touching, and a dial type adjusting device that receives input by turning.

6. The home appliance of claim 2, further comprising a display that outputs a loudness of the sound according to the amplitude of the at least one acoustic signal in the form of an image.

7. The home appliance of claim 2, wherein, after the conversion device converts the product information into a first acoustic signal upon receipt of the control command from the input device and the output device outputs a first sound corresponding to the first acoustic signal, if the control command is re-input through the input device, the controller controls the conversion device to convert the product information into a second acoustic signal which is a signal having a different amplitude from that of the first acoustic signal.

8. The home appliance of claim 7, wherein the second acoustic signal has a larger amplitude than that of the first acoustic signal.

9. The home appliance of claim 2, further comprising a sound input device that receives a re-transmit command sound and delivers the same to the controller, wherein, after the conversion device converts the product information into a first acoustic signal and the output device outputs a first sound corresponding to the first acoustic signal, if a re-transmit command sound is input into the sound input device, the controller controls the conversion device to convert the product information into a second acoustic signal having a different amplitude from that of the first acoustic signal.

10. The home appliance of claim 9, wherein the second acoustic signal has a larger amplitude than that of the first acoustic signal.

11. The home appliance of claim 1, wherein the controller adjusts a frequency band of the at least one acoustic signal and corresponding sound by controlling the conversion device.

12. The home appliance of claim 11, further comprising a frequency selection device configured to allow a user to set a frequency band of the at least one acoustic signal adjusted by the controller.

13. The home appliance of claim 11, wherein the controller controls the conversion device to convert the product information into a first acoustic signal and then into a second acoustic signal, which is a signal having a different frequency band from that of the first acoustic signal.

14. The home appliance of claim 13, wherein the first acoustic signal comprises a plurality of first unit signals that sustain for a predetermined period of time, wherein each of the plurality of first unit signals is a first frequency signal or a second frequency signal having a different frequency from that of the first frequency signal, wherein the second acoustic signal includes a plurality of second unit signals that sustain for a predetermined period of time, and wherein each of the plurality of second unit signals is a third frequency signal or a fourth frequency signal having a different frequency from that of the third frequency signal.

15. The home appliance of claim 11, wherein, after the conversion device converts the product information into a first acoustic signal upon receipt of the control command from the input device and the output device outputs a first sound corresponding to the first acoustic signal, if the control command is re-input from the input device, the controller controls the conversion device to convert the product information into a second acoustic signal which is a signal having a different frequency band from that of the first acoustic signal.

16. The home appliance of claim 15, wherein the first acoustic signal includes a plurality of first unit signals that sustain for a predetermined period of time, wherein each of the plurality of first unit signals is a first frequency signal or a second frequency signal having a different frequency from that of the first frequency signal, wherein the second acoustic signal includes a plurality of second unit signals that sustain for a predetermined period of time, and wherein each of the plurality of second unit signals is a third frequency signal or a fourth frequency signal having a different frequency from that of the third frequency signal.

17. The home appliance of claim 11, further comprising:
a sound input device configured to receive a re-transmit request command from outside of the home appliance and deliver the same to the controller, wherein, after the conversion device converts the product information into a first acoustic signal upon receipt of the re-transmit command from the input device and the output device outputs a first sound corresponding to the first acoustic signal, if a re-transmit request command is input through the sound input device, the controller controls the conversion device to convert the product information into a second acoustic signal, which is a signal having a different frequency band from that of the first acoustic signal.

18. The home appliance of claim 17, wherein the first acoustic signal includes a plurality of first unit signals that sustain for a predetermined period of time, wherein each of the plurality of first unit signals is a first frequency signal or a second frequency signal having a different frequency from that of the first frequency signal, wherein the second acoustic signal includes a plurality of second unit signals that sustain for a predetermined period of time, and wherein each of the plurality of second unit signals is a third frequency signal or a fourth frequency signal having a different frequency from that of the third frequency signal.

19. The home appliance of claim 1, wherein the input device comprises a user input device that receives the control command for fault diagnosis.

20. The home appliance of claim 1, wherein the product information contains at least one of operation information or fault information.

21. A home appliance system, comprising:
a home appliance that converts product information into at least one acoustic signal upon receipt of a control command for fault diagnosis, outputs a sound corresponding to the at least one acoustic signal, when the fault diagnosis command is received, wherein the characteristic of the sound can be adjusted;
an external terminal connected to a communications network to transmit the sound via the communications network; and
a management device that receives the sound and inversely converts the received sound into the product information.

22. The home appliance system of claim 21, wherein the home appliance adjusts an amplitude of the sound.

23. The home appliance system of claim 22, wherein the home appliance comprises:
an output device configured to output the sound;
an input device configured to received a control command from outside of the home appliance;
a controller that includes a storage device for storing the product information of the home appliance for the fault diagnosis, and loads the product information stored in the storage device and outputs a control signal to adjust the amplitude of the sound being output by the output device, when the control command for fault diagnosis is input through the input device; and
a conversion device that converts the control signal which includes product information into at least one acoustic signal which operates the output device to output the sound corresponding to the at least one acoustic signal.

24. The home appliance system of claim 23, wherein the home appliance further comprises an amplitude adjusting device configured to allow a user to set the amplitude of the at least one acoustic signal which is adjusted by the controller.

25. The home appliance system of claim 23, wherein the home appliance further comprises an amplitude adjusting device configured to allow a user to set a volume of the sound.

26. The home appliance system of claim 23, wherein the home appliance further comprises a display device that outputs a loudness of the sound according to the amplitude of the at least one acoustic signal in the form of an image.

27. The home appliance system of claim 22, wherein, after product information is converted into a first acoustic signal upon receipt of the control command and a first sound corresponding to the first acoustic signal is output, if the control command is re-input, the home appliance converts the product information into a second acoustic signal having a different amplitude from that of the first acoustic signal, and outputs a second sound corresponding to the second sound.

28. The home appliance system of claim 27, wherein the second acoustic signal has a larger amplitude than that of the first acoustic signal.

29. The home appliance system of claim 22, wherein the management device comprises:
a transmission/reception device connected to the external terminal by the communications network that receives the sound through the communications network;
a signal conversion device that converts the sound into the product information; and
a management device controller that reads the converted product information.

30. The home appliance system of claim 29, wherein the home appliance converts the product information into a first acoustic signal upon receipt of the control command and outputs a first sound corresponding to the first acoustic signal, the external terminal sends the first signal to the management device, the management device receives the first sound and, if the received first sound cannot be inversely converted into the product information, sends a re-transmit command to the external terminal, the external terminal outputs a re-transmit command sound corresponding to the re-transmit command, and the home appliance converts the product information into a second acoustic signal having a different amplitude from that of the first acoustic signal, upon receipt of the re-transmit command sound, and outputs a second sound corresponding to the second acoustic signal.

31. The home appliance system of claim 30, wherein the second acoustic signal has a larger amplitude than that of the first acoustic signal.

32. The home appliance system of claim 22, wherein the home appliance adjusts an frequency band of the sound.

33. The home appliance system of claim 32, wherein the home appliance comprises:
an output device configured to output the sound;
an input device configured to received a control command from outside of the home appliance;
a controller that includes a storage device for storing the product information of the home appliance for the fault diagnosis, and loads the product information stored in the storage device and outputs a control signal to adjust the frequency band of the sound being output by the output device, when the control command for fault diagnosis is input through the input device; and
a conversion device that converts the control signal which includes product information into at least one acoustic signal which operates the output device to output the sound corresponding to the at least one acoustic signal.

34. The home appliance system of claim 33, wherein the home appliance further comprises a frequency selection device configured to allow a user to set the frequency band of the at least one acoustic signal which is adjusted by the controller.

35. The home appliance system-of claim 33, wherein, when the control command is received through the input device, the home appliance converts the product information into a first acoustic signal and then converts the product information into a second acoustic signal which is a signal having a different frequency band from that of the first acoustic signal.

36. The home appliance system of claim 35, wherein the first acoustic signal includes a plurality of first unit signals that sustain for a predetermined period of time, wherein each of the plurality of first unit signals is a first frequency signal or a second frequency signal having a different frequency from that of the first frequency signal, wherein the second acoustic signal includes a plurality of second unit signals that sustain for a predetermined period of time, and wherein each of the plurality of second unit signals is a third frequency signal or a fourth frequency signal having a different frequency from that of the third frequency signal.

37. The home appliance system of claim 32, wherein, after product information is converted into a first acoustic signal upon receipt of the control command and a first sound corresponding to the first acoustic signal is output, if the control command is re-input, the home appliance converts the product information into a second acoustic signal, which is a signal having a different frequency band from that of the first acoustic signal, and outputs a second sound corresponding to the second sound.

38. The home appliance system of claim 37, wherein the first acoustic signal includes a plurality of first unit signals that sustain for a predetermined period of time, wherein each of the plurality of first unit signals is a first frequency signal or a second frequency signal having a different frequency from that of the first frequency signal, wherein the second acoustic signal includes a plurality of second unit signals that sustain for a predetermined period of time, and wherein each of the plurality of second unit signals is a third frequency signal or a fourth frequency signal having a different frequency from that of the third frequency signal.

39. The home appliance system of claim 32, wherein the management device comprises:
a transmission/reception device connected to the external terminal by the communications network that receives the sound through the communications network;
a signal conversion device that converts the sound into the product information; and
a management device controller that reads the converted product information.

40. The home appliance system of claim 39, wherein the home appliance converts product information into a first acoustic signal upon receipt of the control command and outputs a first sound corresponding to the first acoustic signal, wherein the external terminal sends the first signal to the management device, wherein the management device receives the first sound and, if the received first signal cannot be inversely converted into the product information, sends a re-transmit command to the external terminal, wherein the external terminal outputs a re-transmit command sound corresponding to the re-transmit command, and wherein the home appliance converts the product information into a second acoustic signal, which is a signal of a different frequency band from that of the first acoustic signal, upon receipt of the re-transmit command sound, and outputs a second sound corresponding to the second acoustic signal.

41. The home appliance system of claim 40, wherein the first acoustic signal includes a plurality of first unit signals that sustain for a predetermined period of time, wherein each of the plurality of first unit signals is a first frequency signal or a second frequency signal having a different frequency from that of the first frequency signal, wherein the second acoustic signal includes a plurality of second unit signals that sustain for a predetermined period of time, and wherein each of the plurality of second unit signals is a third frequency signal or a fourth frequency signal having a different frequency from that of the third frequency signal.

42. The home appliance system of claims 29 or 39, wherein the management device further includes a display device that outputs the converted product information in the form of an image.

43. The home appliance system of claim 21, wherein the product information contains at least one of operation information or fault information.
